(19) United States
(12) Patent Application Publication
(10) Pub. No.: US 2007/0243858 A1
(43) Pub. Date: Oct. 18, 2007

(54) Methods, systems, and computer program products for integrated notification of missed calls across multiple phone types

(75) Inventors: Rohini Marathe, Cary, NC (US); Patricia A. Baldwin, Raleigh, NC (US)

Correspondence Address: JENKINS, WILSON, TAYLOR & HUNT, P. A., SUITE 1200, UNIVERSITY TOWER, 3100 TOWER BOULEVARD, DURHAM, NC, 27707, US

(73) Assignee: Tekelec

(21) Appl. No.: 11/516,678

(22) Filed: Sep. 6, 2006

Related U.S. Application Data
(60) Provisional application No. 60/792,835, filed on Apr. 18, 2006.

(51) Int. Cl. H04Q 7/22

(52) U.S. Cl. 455/412.2

(57) ABSTRACT

Methods, systems, and computer program products for integrated notification of missed calls across multiple phone types are disclosed. According to one aspect, a method may include detecting missed call occurrences between at least one calling party and a plurality of terminals of different types associated with a called subscriber. Further, message indicating the missed call occurrences may be communicated to a call log server separate from the terminals. Indications of the missed call occurrence for the called subscriber can be stored at the call log server. The subscriber may be notified of the missed call occurrences via a common terminal accessible by the subscriber. The subscriber may establish a call with the calling party using a click-to-dial interface.

### RELATED APPLICATIONS

This application claims the benefit of U.S. Provisional Patent Application Ser. No. 60/792,835, filed Apr. 18, 2006; the disclosure of which is incorporated herein by reference in its entirety.

### TECHNICAL FIELD

The subject matter described herein relates to methods, systems, and computer program products for monitoring missed calls. More particularly, the subject matter described herein relates to methods, systems, and computer program products for integrated notification of missed calls across multiple phone types.

### BACKGROUND

Subscribers to telecommunications services frequently miss calls to their phones as a result of a call being unanswered by the subscriber, the phone being turned off, or a calling party not leaving a voice mail message. Further, in the case of a mobile terminal, a call may be missed if the mobile terminal is out of range of wireless service. Further, a subscriber may be unable to identify a calling party associated with a missed call. It is undesirable to miss a call and be unable to identify a calling party associated with the missed call because the call may be related to an important matter to the subscriber.

A subscriber may desire to identify a calling party associated with a missed call in order to return the missed call to the calling party. Further, a subscriber may desire to return a missed call from a phone other than the phone to which the call was directed. For example, a missed call may be placed to an unavailable mobile terminal. The subscriber may desire to return the call to the calling party by using a phone other than the mobile terminal. It may be desirable to return the call by using a different phone because the quality of service (QoS) available to the mobile phone is poor or to avoid roaming charges to the mobile terminal. In addition, if the only other phone available to the subscriber is a phone where a toll is charged for making outgoing calls (such as a hotel room phone), it may be desirable to allow the subscriber to set up the call as an incoming call to the hotel room phone to avoid the toll.

Telecommunications service providers may desire to provide missed call features to subscribers in order to increase revenue and provide additional services to subscribers. For example, service providers may provide missed call features to subscribers for a flat rate monthly charge. New customers may also be attracted to service providers offering missed call features.

Yet another problem associated with missed calls is that there is no integrated method for subscribers to receive notification of missed calls on different types of phones that the subscriber owns. For example, the subscriber may be notified of missed calls to the subscriber's mobile phone by checking voice mail. Other phone types, such as the subscriber's voice over IP (VoIP) phone may include separate voice mail that must be checked in order to identify missed calls. Requiring the subscriber to check multiple voice mail systems or other resources to identify missed calls is cumbersome and what will likely result in delays in the subscriber returning missed calls.

Accordingly, in view of the need for missed call features, there exists a need for improved methods, systems, and computer program products relating to missed call features, such as notifying a subscriber of a missed call, for providing click-to-dial service for missed calls, and for integrated notification of missed calls across multiple phone types.

### SUMMARY

According to one aspect, the subject matter described herein includes a method for integrated notification of missed calls across a plurality of phone types. The method includes detecting, at a missed call identification function, missed call occurrences between at least one calling party and a plurality of terminals of different types associated with a called subscriber. The missed call identification function communicates messages indicating the missed call occurrences to a call log server separate from the terminals. Indications of the missed call occurrences for the called subscriber are stored at the call log server. Further, the call log server notifies the subscriber of the missed call occurrences via a common terminal accessible by the subscriber.

According to another aspect, the subject matter described herein may allow a subscriber to establish a call with a calling party associated with a missed call. One exemplary method for establishing such a call may include allowing a subscriber to establish such a call as incoming call legs to both ends of the call using a click-to-dial interface.

According to another aspect, the subject matter described herein includes a method for integrated notification of missed call occurrences across multiple phone types. In one method, at a call log server, occurrences of missed calls for a plurality of phone types used by a subscriber are logged. Notification of the missed call occurrences are delivered to a terminal accessible by the subscriber.

The subject matter described herein can be implemented as a computer program product comprising computer executable instructions embodied in a computer readable medium. Exemplary computer readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform. Alternatively, the subject matter described herein can be implemented on a computer program product that is distributed across multiple devices or computing platforms.

### BRIEF DESCRIPTION OF THE DRAWINGS

Exemplary embodiments of the subject matter will now be explained with reference to the accompanying drawings, of which:

FIG. 1 is an example of a telecommunications system for integrated notification of missed calls across a plurality of phone types according to an embodiment of the subject matter described herein;

FIG. 2A is a flow chart of an exemplary process for integrated notification of missed calls across a plurality of phone types according to an embodiment of the subject matter described herein;

FIG. 2B is a flow chart of an exemplary process for notifying a subscriber at an IMS phone of a missed call according to an embodiment of the subject matter described herein;

FIG. 2C is a flow chart of an exemplary process for notifying a subscriber at VoIP phone of a missed call according to an embodiment of the subject matter described herein;

FIG. 3 is a block diagram of exemplary internal architectures of a signal transfer point (STP) signaling message routing node and a call log server according to an embodiment of the subject matter described herein;

FIG. 4 is a computer screen display of an exemplary window for notifying a subscriber of a missed call occurrence according to an embodiment of the subject matter described herein;

FIG. 5 is a message flow diagram of an exemplary exchange of session initiation protocol (SIP) messages for voice mail service among a SIP proxy of a calling party phone, a SIP proxy of a subscriber phone, a VoIP application server, and an interactive voice response (IVR)/voice mail server according to an embodiment of the subject matter described herein;

FIG. 6 is an example of a telecommunications system for reporting a missed call to a subscriber and initiating a call to a calling party associated with the missed call according to an embodiment of the subject matter described herein;

FIG. 7 is a block diagram of an exemplary STP/signaling gateway (SG) including a call log server database according to an embodiment of the subject matter described herein; and

FIG. 8 is a flow chart of exemplary steps for integrated notification of missed calls across multiple phone types according to an embodiment of the subject matter described herein.

### DETAILED DESCRIPTION

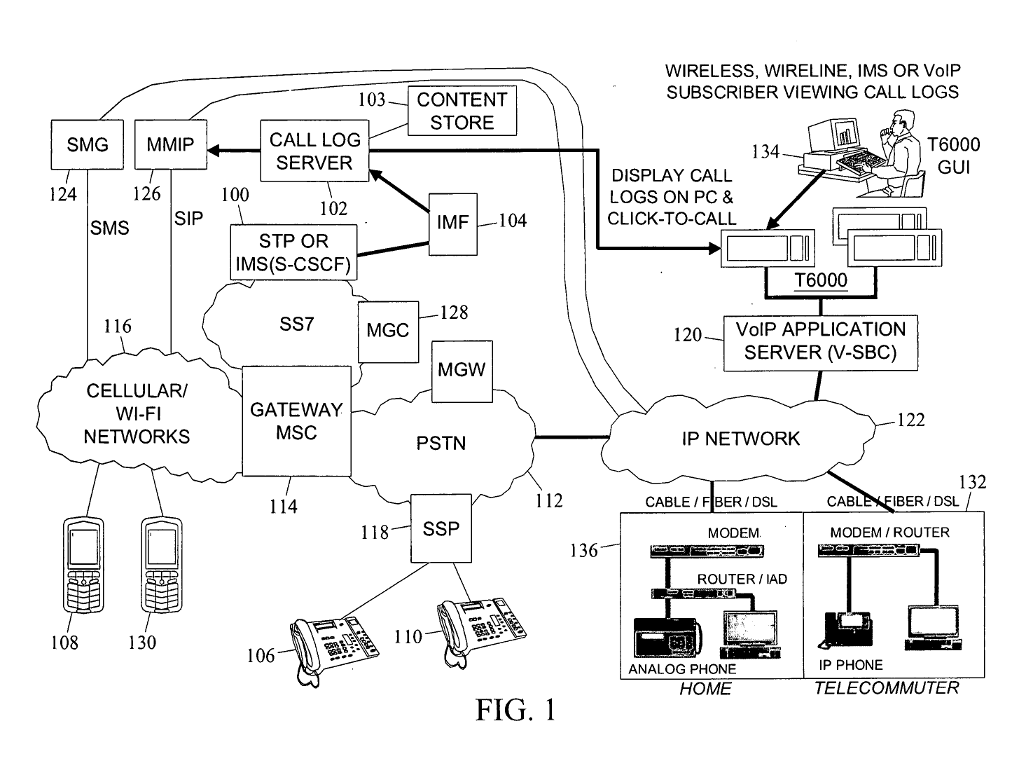

According to one aspect, a telecommunications system for integrated notification of missed calls across a plurality of phone types may be implemented as hardware, software, and/or firmware components executing on one or more components of a network. FIG. 1 illustrates an example of a telecommunications system for integrated notification of missed calls across a plurality of phone types according to an embodiment of the subject matter described herein. Referring to FIG. 1, the system may include an STP/IP multimedia subsystem (IMS) message routing node 100 operable to route signaling messages for STP and IMS. The IMS functionality of routing node 100 may be operable to function as a serving call session control function (S-CSCF) for collecting SIP information for IMS phones. For example, the S-CSCF may be function to manage mobile registrations, maintain sessions, and interact with other services. Further, routing node 100 may be operable to determine a missed call occurrence between a calling party and a subscriber. For example, routing node 100 may receive one or more signaling messages indicating the occurrence of a missed call between a calling party and a subscriber's wireline phone, wireless phone, session initiation protocol (SIP) phone, or IP phone. Based on the signaling messages, routing node 100 may determine the missed call occurrence and communicate a message indicating the missed call occurrence to a call log server 102. An integrated message feed (IMF) 104 associated with routing node 100 may collect the messages associated with missed call occurrences and may deliver the messages to downstream functions, such as call log server 102. Call log server 102 may receive the messages indicating the missed call occurrence and store an indication of the missed call occurrence for the subscriber in a content store 103. Call log server 102 may notify the subscriber of the missed call occurrence. In one implementation, as will be described in more detail, routing node 100 may collect messages relating to missed call occurrences for multiple phone types used by a subscriber and may deliver the messages to call log server 102. Call log server 102 may notify the subscriber of the occurrences of multiple missed calls for different phone types at a terminal accessible by the subscriber, such as mobile terminals 108 and 130, land line terminals 106, and 110, or computer terminal 134.

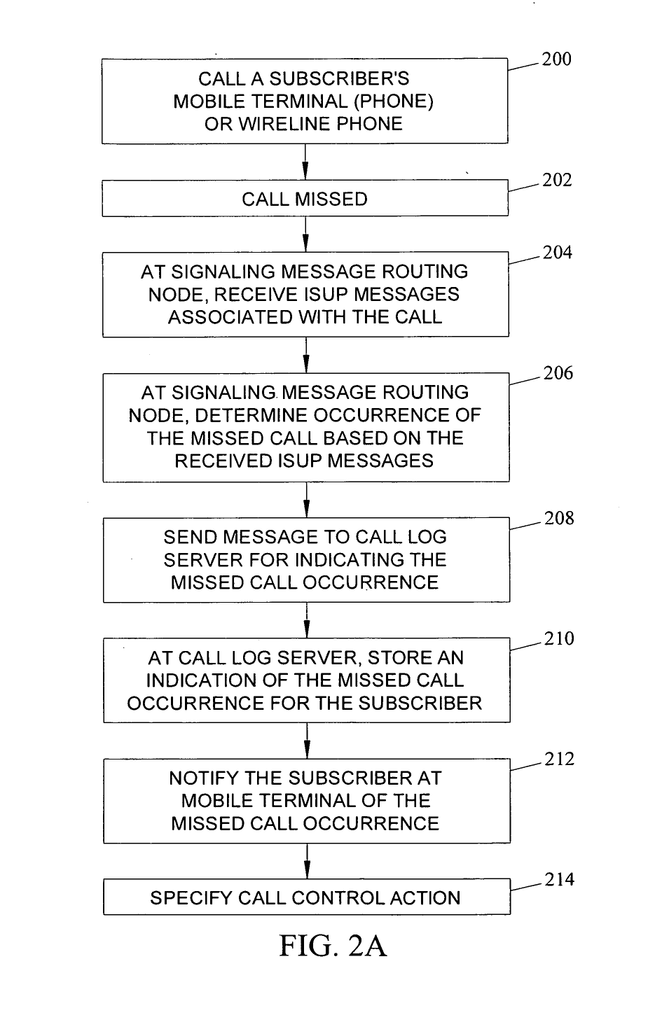

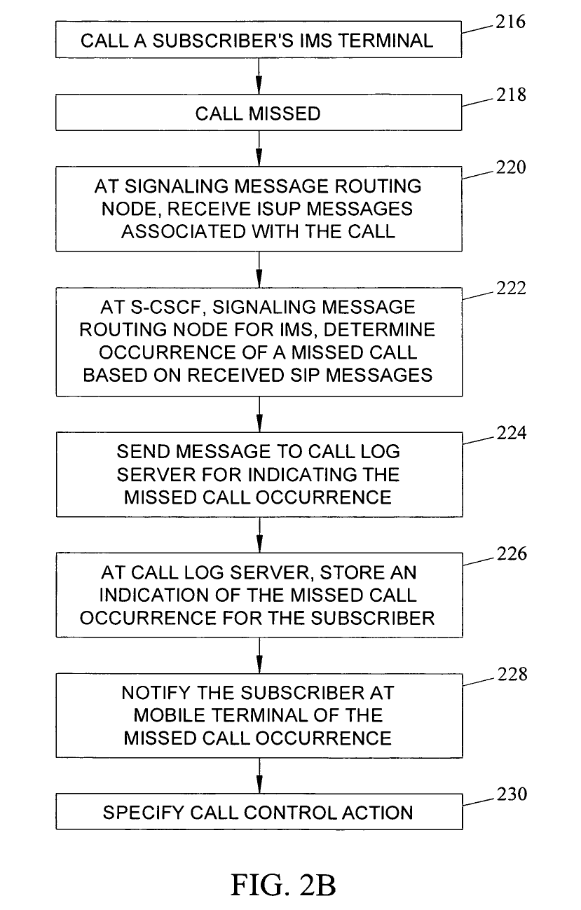

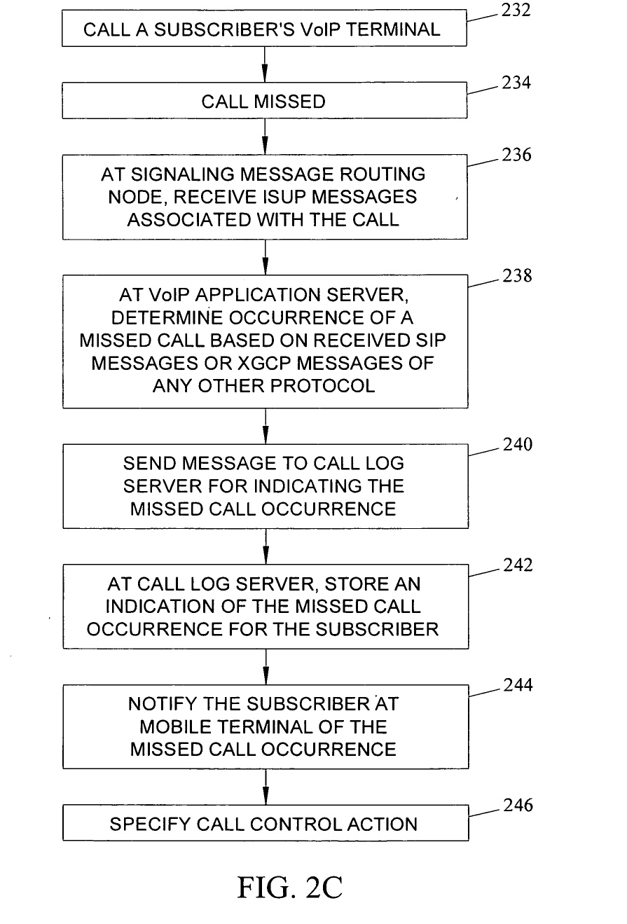

FIG. 2A is a flow chart of an exemplary process for integrated notification of missed calls across a plurality of phone types according to an embodiment of the subject matter described herein. Referring to FIGS. 1 and 2A, a calling party may use a wireline phone 106 for calling a wireless subscriber's cellular mobile terminal 108 (block 200). The subscriber may miss the call because terminal 108 is unavailable (block 202). Terminal 108 may be unavailable when terminal 108 is turned off, terminal 108 is out of range, the call is unanswered by the subscriber, terminal 108 does not receive call delivery, or the calling party does not leave a voice mail message.

Alternatively, in block 200, a calling party may use wireline phone 106 for calling another wireline phone 110. In this alternative, the subscriber may miss the call because phone 110 is unanswered by the subscriber, phone 110 does not receive call delivery, or the calling party does not leave a voice mail message.

A PSTN 112, a gateway media gateway controller (MSC) 114, and cellular/Wi-Fi networks 116 may be involved in the process of the call attempt between phone 106 and mobile terminal 108. In the process of the call attempt between phones 106 and 110, PSTN 112 and a service switching point (SSP) 118 may be involved. During the call attempt between phone 106 and mobile terminal 108, routing node 100 may receive ISDN user part (ISUP) messages directed towards mobile terminal 108 and towards voice mail associated with mobile terminal 108 (block 204). For example, routing node 100 may receive one or more ISUP initial address messages (IAMs), ISUP answer messages (ANMs), ISUP answer complete messages (ACMs) and ISUP release (REL) messages for the attempted call. Based on the received ISUP messages, routing node 100 may detect the occurrence of a missed call (block 206). For example, IMF 104 associated with routing node 100 may observe messages that are involved in the call attempt and determine the occurrence of a missed call to mobile terminal 108 or to voice mail associated with the subscriber. In one embodiment, routing node 100 and/or IMF 104 may determine the occurrence a missed call by determining that a calling party disconnects a call prior to the call being routed to the subscriber's voice mail. For example, an ISUP IAM message followed by an ISUP REL message may indicate a missed call. In another example, ISUP messaging indicating that the call is routed directly to voice mail may indicate a missed call. Missed call occurrences between one or more calling parties and a plurality of terminals of different types associated with the subscriber may be detected.

At block 208 of FIG. 2A, routing node 100 may send a message to call log server 102 for indicating the missed call occurrence for the subscriber. There may be one or more messages sent to call log server 102 that indicate missed call occurrences between calling parties and terminals of different types associated with the subscriber. Call log server 102 may be operable to store an indication of one or more of the missed call occurrences for the subscriber (block 210). For example, the stored indication may be a call record indicating a missed call to the subscriber's mobile terminal 108 or to voice mail. The call record may indicate a name associated with the calling party, a directory number associated with the calling party, and a time that the missed call was received.

Further, call log server 102 may notify the subscriber of the one or more missed call occurrences at the subscriber's mobile terminal 108 (block 212) or another suitable common terminal accessible by the subscriber. A call record indicating the missed call occurrence may be forwarded to the subscriber via a VoIP application server 120. In one example, call log server 102 may deliver a 2G or 3G message to subscriber's mobile terminal 108 via networks 116 for notifying the subscriber of the missed call occurrence. A 2G or 3G message may be delivered via a short message gateway (SMG) 124 or a multimedia mobile information portal (MMIP) 126. A display of mobile terminal 108 may indicate the missed call and call record information associated with the missed call.

A subscriber may specify a call control action at mobile terminal 108 (block 214). The subscriber may specify the call control action in response to receiving notification of a missed call. The call control action may include establishing a connection between a phone accessible by the subscriber and the calling party associated with the missed call occurrence. For example, a GUI of mobile terminal 108 may provide an option that a subscriber may select for establishing a call between phone 110 and calling party phone 106. The subscriber may choose to set up a call between phone 110 and calling party phone 106 in order to avoid roaming charges. The subscriber may enter user input for selecting the directory number for establishing a call associated with the directory number. In one exemplary implementation, the GUI used to establish the call may be a click-to-dial interface where the user can click on the number to dial to initiate the call.

In an example of a call control action, a GUI of mobile terminal 108 may display a directory number associated with phone 110 and provide an option that a subscriber may select for establishing a call with phone 106. The GUI may display a directory number associated with phone 106. The subscriber may enter input to select the directory number for calling the phone associated with the displayed directory number. In response to the subscriber's selection, mobile terminal 108 may communicate instructions to VoIP application server 120 for establishing a call between phone 106 and phone 110. In response to receiving the call setup instructions, VoIP application server 120 may communicate a message to a media gateway controller (MGC) 128 via IP network 122 for setting up a call between phone 106 and phone 110.

FIG. 2B is a flow chart of an exemplary process for notifying a subscriber at an IMS phone of a missed call according to an embodiment of the subject matter described herein. Referring to FIGS. 1 and 2B, a calling party may use wireline phone 106 for calling a subscriber's IMS phone 130 (block 216). The subscriber may miss the call because IMS phone 130 is unavailable (block 218). IMS phone 130 may be unavailable when terminal 108 is turned off, terminal 108 is out of range, the call is unanswered by the subscriber, IMS phone 130 does not receive call delivery, or the calling party does not leave a voice mail message.

PSTN 112, MSC 114, cellular/Ni-Fi networks 116, and SSP 118 may be involved in the process of the call attempt between phone 106 and IMS phone 130. During the call attempt between phone 106 and IMS phone 130, routing node 100 may receive SIP messages directed towards IMS phone 130 and towards voice mail associated with IMS phone 130 (block 220). For example, routing node 100 may receive one or more SIP messages for the attempted call. Based on the received SIP messages, routing node 100 may determine the occurrence of a missed call (block 206). Further, at the S-CSCF of routing node 100, an occurrence of a missed call may be determined based on received SIP messages associated with IMS phone 130 (block 222). For example, a SIP message may indicate that a call to IMS phone 130 was unanswered.

At block 224 of FIG. 2B, routing node 100 may send a message to call log server 102 for indicating the missed call occurrence for the subscriber. Call log server 102 may be operable to store an indication of the missed call occurrence for the subscriber (block 226). For example, the stored indication may be a call record indicating a missed call to the subscriber's IMS phone 130 or to voice mail. The call record may indicate a name associated with the calling party, a directory number associated with the calling party, and a time that the missed call was received.

Further, call log server 102 may notify the subscriber of the missed call occurrence at the subscriber's IMS phone 130 (block 228). A call record indicating the missed call occurrence may be forwarded to the subscriber via a multimedia mobile information portal (MMIP) 126. In one example, VoIP application server 120 may deliver a 3G message to subscriber's IMS phone 130 via an Internet connection for notifying the subscriber of the missed call occurrence. The Internet connection may be through IP network 122 and an SMG 124 or an MMIP 126. A display of IMS phone 130 may indicate the missed call and call record information associated with the missed call.

A subscriber may specify a call control action at IMS phone 130 (block 230). The subscriber may specify the call control action in response to receiving notification of a missed call. The call control action may include establishing a connection between a phone accessible by the subscriber and the calling party associated with the missed call occurrence. For example, a GUI of IMS phone 130 may provide an option that a subscriber may select for establishing a call between phone 110 and calling party phone 106. The subscriber may choose to set up a call between phone 110 and calling party phone 106 in order to avoid roaming charges. The subscriber may enter user input for selecting the directory number for establishing a call associated with the directory number. In one exemplary implementation, the GUI used to establish the call may be a click-to-dial interface where the user can click on the number to dial to initiate the call.

In an example of a call control action, a GUI of IMS phone 130 may display a directory number associated with phone 106 and provide an option that a subscriber may select for establishing a call with phone 106. The GUI may display a directory number associated with phone 106. The subscriber may enter input to select the directory number for calling the phone associated with the displayed directory number. In response to the subscriber's selection, IMS phone 130 may communicate instructions to VoIP application server 120 for establishing a call between phone 106 and phone 110. In response to receiving the call setup instructions, VoIP application server 120 may communicate a message to MGC 128 via IP network 122 for setting up a call between phone 106 and phone 110.

FIG. 2C is a flow chart of an exemplary process for notifying a subscriber at VoIP phone of a missed call according to an embodiment of the subject matter described herein. For example, a call to a VoIP phone 132 of a telecommuter phone system may be missed. The telecommuter phone system may also include a modem/router and a computer. Referring to FIGS. 1 and 2C, a calling party may use wireline phone 106 for calling a subscriber's VoIP phone 132 (block 232). The subscriber may miss the call because VoIP phone 132 is unavailable (block 234). VoIP phone 132 may be unavailable when VoIP phone 132 is turned off, the call is unanswered by the subscriber, VoIP phone 132 does not receive call delivery, or the calling party does not leave a voice mail message.

PSTN 112, MSC 114, SSP 118, VoIP application server 120, and IP network 122 may be involved in the process of the call attempt between phone 106 and VoIP phone 132. During the call attempt between phone 106 and VoIP phone 132, VoIP application server 120 may receive SIP messages directed towards VoIP phone 132 and towards voice mail associated with VoIP phone 132 (block 236). For example, VoIP application server 120 may receive one or more SIP messages for the attempted call. Further, for example, VoIP application server 120 may receive SIP messages, media gateway control protocol (XGCP) messages, or other messages in accordance with other protocols. Based on the received messages at VoIP application server 120 associated with VoIP phone 132, VoIP application server 120 may determine the occurrence of a missed call (block 238). For example, a SIP message may indicate that a call to VoIP phone 132 was unanswered.

At block 240 of FIG. 2C, VoIP application server 120 may send a message to call log server 102 for indicating the missed call occurrence for the subscriber. Call log server 102 may be operable to store an indication of the missed call occurrence for the subscriber (block 242). For example, the stored indication may be a call record indicating a missed call to the subscriber's VoIP phone 132 or to voice mail. The call record may indicate a name associated with the calling party, a directory number associated with the calling party, and a time that the missed call was received.

Further, call log server 102 may notify the subscriber of the missed call occurrence at the subscriber's VoIP phone 132 (block 244). A call record indicating the missed call occurrence may be forwarded to the subscriber via VoIP application server 120. The notification may be communicated through IP network 122. A display of VoIP phone 132 may indicate the missed call and call record information associated with the missed call.

A subscriber may specify a call control action at VoIP phone 132 (block 246). The subscriber may specify the call control action in response to receiving notification of a missed call. The call control action may include establishing a connection between a phone accessible by the subscriber and the calling party associated with the missed call occurrence. For example, a GUI of VoIP phone 132 may provide an option that a subscriber may select for establishing a call between VoIP phone 132 and calling party phone 106. The subscriber may enter user input for selecting the directory number for establishing a call associated with the directory number. In one exemplary implementation, the GUI used to establish the call may be a click-to-dial interface where the user can click on the number to dial to initiate the call.

In an example of a call control action, a GUI of VoIP phone 132 may display a directory number associated with phone 106 and provide an option that a subscriber may select for establishing a call with phone 106. The GUI may display a directory number associated with phone 106. The subscriber may enter input to select the directory number for calling the phone associated with the displayed directory number. In response to the subscriber's selection, VoIP phone 132 may communicate instructions to VoIP application server 120 for establishing a call between phone 106 and VoIP phone 132. In response to receiving the call setup instructions, VoIP application server 120 may communicate a message to MGC 128 via IP network 122 for setting up a call between phone 106 and VoIP phone 132.

In each of the exemplary processes of FIGS. 2A-2C, a subscriber may be notified of a missed call occurrence at a computer 134. For example, a call record indicating the missed call occurrence may be forwarded from VoIP application server 102 to computer 134. In one example, VoIP application server 120 may provide a GUI for computer 134 via IP network 122 for notifying the subscriber of the missed call occurrence. Further, a subscriber may specify a call control action at computer 134. The subscriber may specify the call control action in response to receiving notification of a missed call. The call control action may include establishing a connection between a phone accessible by the subscriber and the calling party associated with the missed call occurrence. For example, a GUI of computer 134 may provide an option that a subscriber may select for establishing a call between phone 110 accessible by the subscriber and calling party phone 106. The subscriber may enter user input for selecting the directory number for establishing a call associated with the directory number. In one exemplary implementation, the GUI used to establish the call may be a click-to-dial interface where the user can click on the number to dial to initiate the call. Computer 134 may communicate instructions to VoIP application server 120 for establishing a call between phones 106 and 110. In response to receiving the call setup instructions, VoIP application server 120 may communicate a message to MGC 128 via IP network 122 for setting up a call between phones 106 and 110 using PSTN 112 and SSP 118.

In one embodiment, a subscriber may input instructions for setting up incoming call legs between phone 110 associated with the subscriber and calling party phone 106 associated with the missed call occurrence. This option may be advantageous when the subscriber desires to avoid outgoing call charges from phone 110. For example, the subscriber may be located in a hotel room and desire to avoid charges to the hotel room phone. In this example, the subscriber may enter the hotel room phone number into the computer and provide instructions for incoming call legs to be established between the hotel room phone and the phone associated with the missed call occurrence. In one embodiment, dual tone multi-frequency (DTMF) tones are specified in order to call the hotel room phone. DTMF assigns a specific frequency (consisting of two separate tones) to each key so that it can easily be identified by a microprocessor.

A call setup may be made between any designated phones. For example, a call may be set up to a home phone system 136 including an analog phone, a computer, a router, and a modem. In another example, a call may be set up to the telecommuter phone system associated with VoIP phone 132.

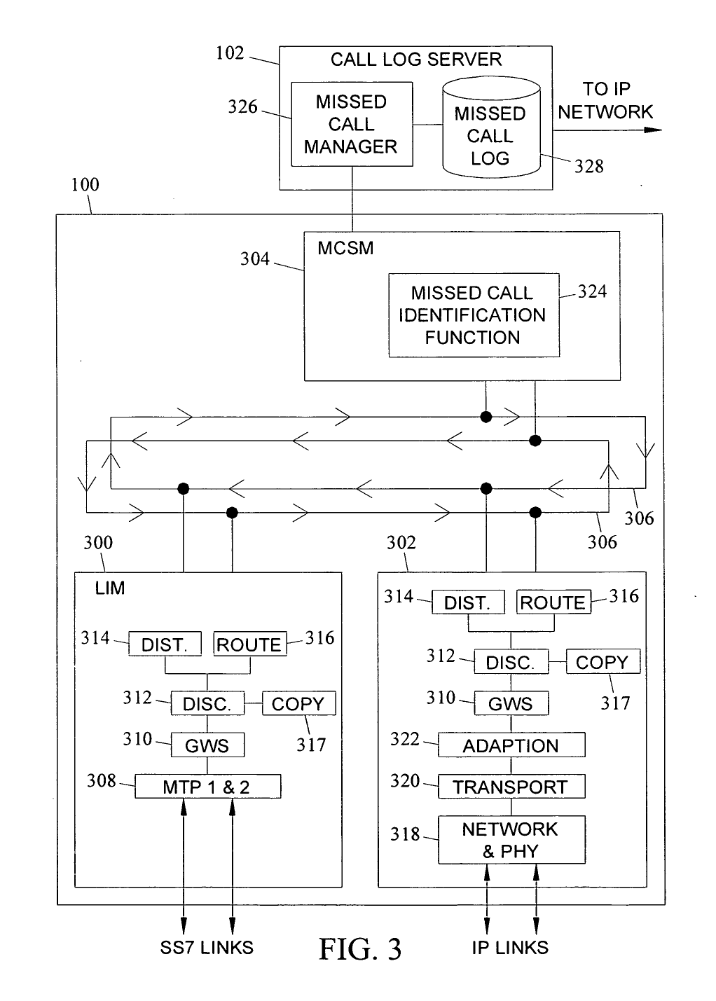

FIG. 3 is a block diagram illustrating exemplary internal architectures of STP signaling message routing node 100 and call log server 102 according to an embodiment of the subject matter described herein. Referring to FIG. 3, routing node 100 includes a plurality of internal processing modules 300, 302, and 304 connected to each other via a counter-rotating, dual-ring bus 306. Processing modules 300, 302, and 304 may each include an application processor and associated memory for implementing a telecommunications signaling function. In addition, each processing module may include a communications processor for communicating with other processing modules via bus 306.

In the illustrated example, processing module 300 comprises a link interface module (LIM) for interfacing with SS7 signaling links. LIM 300 includes a message transfer part (MTP) level 1 and 2 function 308, a gateway screening function 310, a discrimination function 312, a distribution function 314, and a routing function 316. MTP level 1 and 2 function 308 performs MTP level 1 and 2 operations, such as error correction, error detection, and sequencing of SS7 signaling messages. Gateway screening function 310 screens incoming SS7 signaling messages based on one or more parameters in the messages. Discrimination function 312 determines whether a received SS7 signaling message should be distributed to another processing module within routing node 100 for further processing or whether the message should be routed over an outbound signaling link. Discrimination function 312 forwards messages that are to be distributed for internal processing to distribution function 314. Distribution function 314 forwards the messages to the appropriate internal processing module. Routing function 316 routes messages that are required to be routed based on MTP level 3 information in the messages. A message copy function 317 may copy signaling messages associated with call attempts and forward the copies to missed call service module 304. For example, copy function 317 may be configured to copy all received ISUP messages to missed call service module 304.

Processing module 302 comprises a data communications module (DCM) for sending and receiving signaling messages via IP signaling links. DCM 302 includes a network and physical layer function 318, a transport layer function 320, an adaptation layer function 322, and layers 310, 312, 314, and 316 described with regard to LIM 300. Network and physical layer function 318 performs network and physical layer functions for sending and receiving messages over IP links. For example, function 318 may implement IP over Ethernet. Transport layer function 320 implements transport layer functions. For example, transport layer function 320 may implement transmission control protocol (TCP), user datagram protocol (UDP), or stream control transmission protocol (SCTP). Adaptation layer function 322 performs operations for adapting signaling messages, such as SS7 signaling messages, for transport over an IP network. Adaptation layer function 322 may implement using any of the IETF adaptation layer protocols, such as M3UA, M2PA, SUA, TALI, or other suitable adaptation layer protocol. Functions 310, 312, 314, and 316 perform the operations described above for the corresponding numbered components of LIM 300. Processing module 302 may also include a copy function 317 for copying received signaling messages associated with call attempts to missed call service module 304.

Processing module 304 is a missed call service module (MCSM) for providing missed call identification services for received signaling messages. MCSM 304 may include a missed call identification function 324 for determining a missed call occurrence between a calling party and a subscriber. Missed call identification function 324 may receive message copies associated with call attempts from copy functions 317 and identify missed calls from the signaling messages. As stated above, a missed call may be detected by the presence of an ISUP IAM message followed by a REL message relating to the same call or messaging that indicates that a call has been routed to voice mail. In a SIP environment, a SIP Invite message followed by a Cancel message may indicate a missed call. Once a missed call occurrence is detected, a message indicating the missed call occurrence may be generated by missed call identification function 324. Missed call identification function 324 may communicate the message to call log server 102 for indicating the occurrence of the missed call between the calling party and the subscriber. A processing module having the functionality of a MCSM as described herein may also be implemented in a VoIP application server or an S-CSCF for determining a missed call occurrence and for indicating the occurrence of the missed call.

Call log server 102 may include a missed call manager 326 for receiving messages indicating missed call occurrences between calling parties and subscribers. Missed call manager 326 may generate a call record based on each received message and store the call record in a missed call log 328. Missed call manager 326 may be operable to retrieve a call record from missed call log 328 and generate a message for notifying a subscriber of a missed call. The message may be communicated to the subscriber via IP network 122 or a 2G/3G network. In one example, the message may be communicated to the subscriber's mobile terminal. In another example, the message may be communicated to the subscriber's computer. The message may be used by the mobile terminal or computer for displaying information notifying the subscriber of the missed call occurrence.

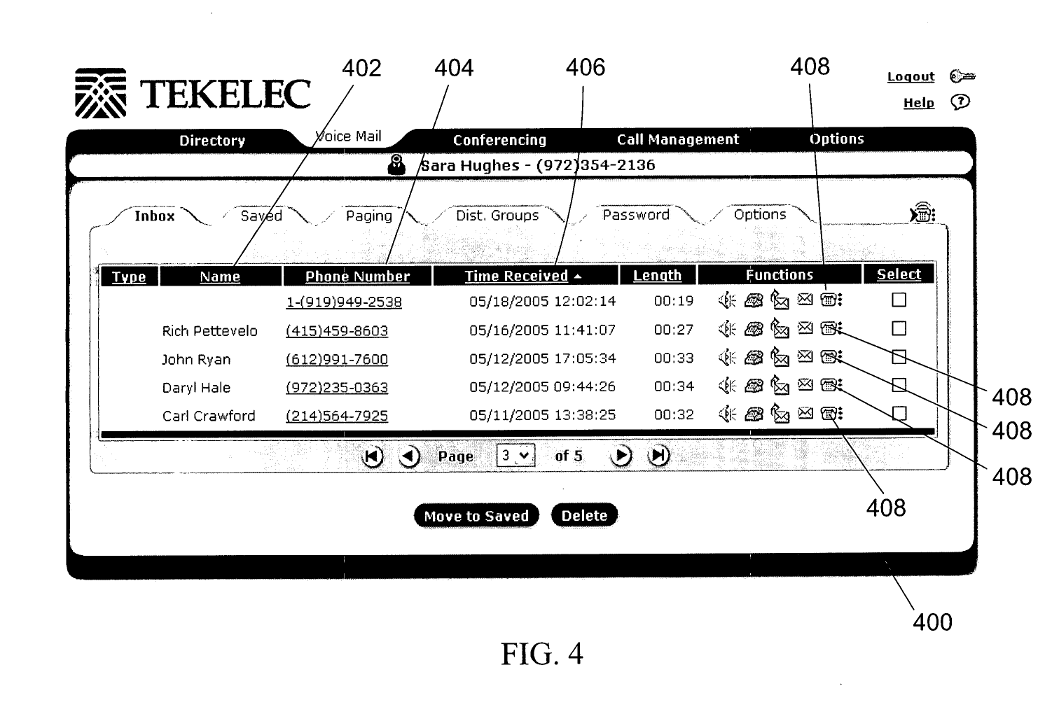

FIG. 4 is a computer screen display of an exemplary window 400 for notifying a subscriber of a missed call occurrence according to one embodiment of the subject matter described herein. Referring to FIG. 4, window 400 includes a table of missed call occurrences. The table includes a column 402 indicating a name associated with the calling party, a column 404 indicating a directory number associated with the calling party, and a column 406 indicating a time that the missed call was received. Each entry also includes a graphical icon 408 that may be selected for establishing a call with the calling party associated with the corresponding entry.

As stated above, a missed call occurrence between a calling party and a subscriber may be determined based on one or more SIP messages. For example, STP 100 may determine a missed call occurrence based on one or more SIP messages. Further, a VoIP application server may be adapted to determine a missed call occurrence and notify a subscriber of the missed call occurrence in accordance with the subject matter described herein. For example, VoIP application server 118 may receive SIP message exchanged between a calling party SIP phone and a subscriber's SIP phone. Based on the SIP messages, server 118 may determine that the subscriber missed the call. VoIP application server 118 may be operable to notify the subscriber of the missed call using a process similar to that described above with respect to FIGS. 2A-2C.

Further, an IVR/voice mail server may be adapted for notifying a subscriber of a missed call occurrence using a process similar to that described above with respect to FIGS. 2A-2C. The IVR/voice mail server may receive SIP messages indicating a missed call to a subscriber. Based on the SIP messages, the IVR/voice mail server may determine a missed call occurrence. In response to determining a missed call occurrence, the IVR/voice, mail server may notify the subscriber of the missed call.

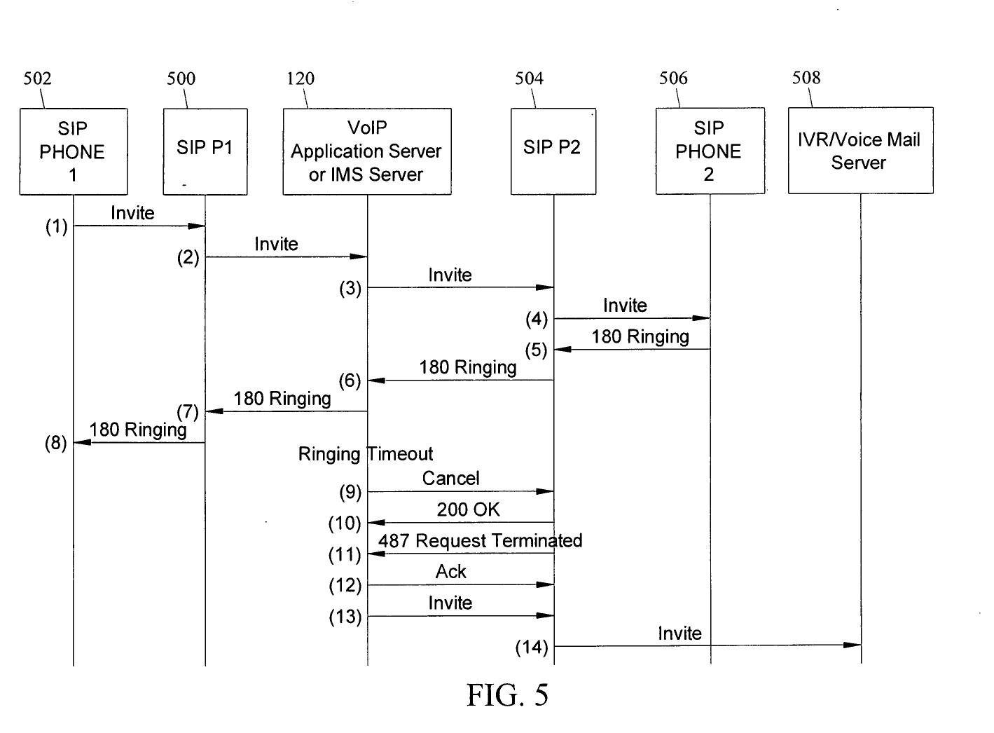

FIG. 5 is a message flow diagram of an exemplary exchange of SIP messages for voice mail service among a SIP proxy 500 of a calling party phone 502, a SIP proxy 504 of a subscriber phone 506, VoIP application server 120, and an IVR/voice mail server 508 according to the subject matter described herein. In this example, a calling party inputs information into phone 502 for calling subscriber's phone 506. Calling party phone 502 and subscriber phone 506 may be served by SIP proxies 500 and 504, respectively. Initially, in step 1, a SIP calling party phone 502 initiates a SIP call by sending a SIP Invite message to SIP proxy 500. In step 2, SIP proxy 500 transmits a SIP Invite message to VoIP application server 120. Alternatively, the SIP Invite message may be transmitted to an IMS server configured to implement the functions of server 120 described in this example. In response to receiving the SIP Invite message, server 120 transmits a SIP Invite message to SIP proxy 504 (step 3). In step 4, SIP proxy 504 transmits a SIP Invite message to the subscriber phone 506. In step 5, the subscriber phone 506 responds with a 180 Ringing SIP message.

In steps 6-8, the 180 Ringing SIP message is transmitted back to calling party phone 502 via SIP proxy 504, VoIP application server 120, and SIP proxy 500. When a ring timeout occurs, VoIP application server 120 may abort the call by sending a SIP Cancel message to SIP proxy 502. Steps 9-12 show the call abort message sequence between VoIP application server 120 and SIP proxy 504. Next, in steps 13 and 14, VoIP application server 120 may forward the call to IVR/voicemail server 508 via SIP proxy 504.

The SIP messages may be forwarded to call log server 102 (shown in FIG. 1). Call log server 102 may include missed call manager 326 (shown in FIG. 3) for receiving messages indicating missed call occurrences between calling parties and subscribers. Missed call manager 326 may generate a call record based on each received message and store the call record in missed call log 328 (shown in FIG. 3). Missed call manager 326 may be operable to retrieve a call record from missed call log 328 and generate a message for notifying a subscriber of a missed call. The message may be communicated to the subscriber via IP network 122 (shown in FIG. 1) or a 2G/3G network. In one example, the message may be communicated to the subscriber's mobile terminal. In another example, the message may be communicated to the subscriber's computer.

Several different types of SIP messages may be monitored and intercepted to provide missed call information. For example, if there is no response from a subscriber, a SIP proxy serving the called party may respond to the calling party with a SIP 480 message which indicates that there was no response from the called party. In another example, if a calling party hangs up before a called party answers, a SIP Cancel message may be generated and used to determine that the call was not answered. In one example, a called party may respond with a SIP 486 message for indicating that the called party did not answer the call. Detection of a SIP 480 message, a SIP Cancel message, or a SIP 486 message may indicate a missed call occurrence.

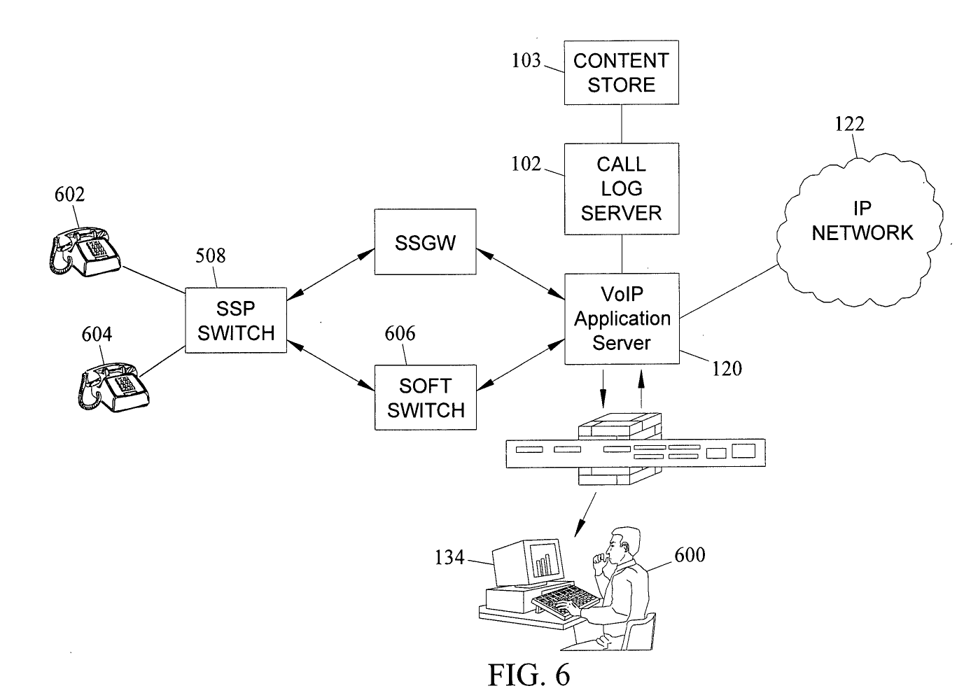

FIG. 6 illustrates an example of a telecommunications system for notifying a subscriber of a missed call and initiating a call to a calling party associated with the missed call according to an embodiment of the subject matter described herein. Referring to FIG. 6, a subscriber 600 may access computer 134 for viewing missed calls according to the subject matter described herein. Computer 134 may display missed calls on a GUI. A list of the missed calls may be displayed by using a web browser running on computer 134 and receiving a call log record from call log server 102 and content store 103 that indicates the missed call occurrence, a calling party, and a directory number associated with the calling party. For example, subscriber may miss a call from a calling party phone 602. Subscriber 600 may input instructions into computer 134 for setting up a call between calling party phone 602 and phone 604, which may be accessible by subscriber 600. Instructions for setting up a call between phones 602 and 604 may be communicated to VoIP application server 120.

VoIP application server 120 may generate and communicate a SIP Invite message to a softswitch 606 for setting up a call between phones 602 and 604. Next, softswitch 602 may generate and communicate a Setup message to a switch-to-switch protocol (SSP) switch 608. Switch 608 may respond to softswitch 606 with a CallProc, Alert, and Conn messages. In response to receiving the messages, softswitch 606 may send a 200 OK SIP message to server 120. Further, softswitch 606 may send a Setup message to Class 5 switching equipment for a directory number (DN) for phone 602. The Class 5 equipment may respond with Call Proc, Alert, and Conn messages. Softswitch 606 may send another 200 OK SIP message to server 118. Next, softswitch 606 and server 120 may interface for connecting the two calls with a Two B-Channel Transfer (TBCT) process.

In the examples above, the call log server is external to the signaling message routing node. However, the subject matter described herein is not limited to such an embodiment. For example, the call log server may be integrated within a signaling message routing node. In such an implementation, the signaling message routing node may receive signaling message from one or more suitable networks and, based on the signaling messages, determined a missed call occurrence for a subscriber. The routing node may store a record of the missed call occurrence in a call log server database. The record indicating the missed call occurrence may be communicated by the routing node to the subscriber.

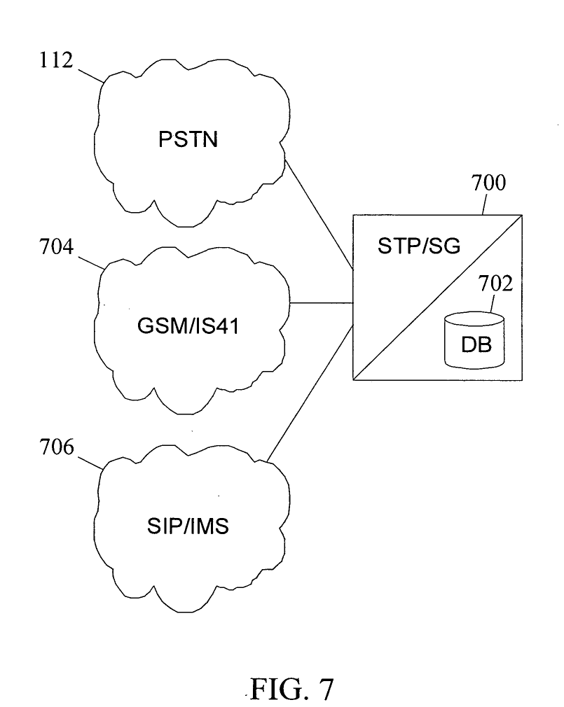

FIG. 7 illustrates a block diagram of an exemplary STP/SG 700 including a call log server database 702 according to the subject matter described herein. STP/SG 700 may receive signaling messages from PSTN 112, a GSM/IS-41 network 704, and a SIP/IMS network 706. Based on the received signaling messages, STP/SG 700 may determine a missed call occurrence for a subscriber. The routing node may store a record of the missed call occurrence in call log server database 702. The record indicating the missed call occurrence may be communicated by STP/SG 700 to the subscriber. Database 702 and missed call occurrence notification functionality may be in components either internal or external to STP/SG 700.

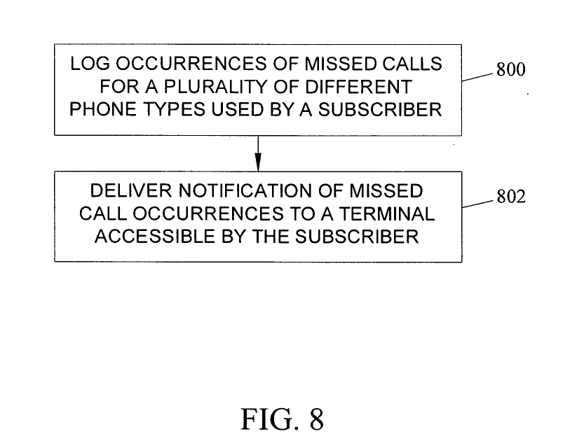

According to another aspect, the subject matter described herein includes a method for integrated notification of missed call occurrences across multiple phone types used by a subscriber. Such a method maybe useful for delivering notification of missed calls received on any other subscriber phone to a single location, such as a mobile terminal or computer terminal accessible by the subscriber. FIG. 8 is a flow chart illustrating exemplary steps for integrated notification of a missed call occurrence across multiple phone types according to an embodiment of the subject matter described herein. Referring to FIG. 8, in step 800, missed call occurrences for a plurality of different phone types are logged at a call log server. The missed call occurrences may be logged using the methods described above and call log server 102. The phone types for which missed calls may be logged include any phone types used by the subscriber, such as mobile phones, VoIP, and land line phones.

In step 802, notification of the missed call occurrences are delivered to a terminal accessible by the subscriber. In one implementation, notification of the missed call occurrences may be sent to a subscriber's mobile terminal, for example, the one or more SMS messages that contains the missed call information for each missed call and each phone type. In another example, missed call occurrences may be delivered to a computer terminal accessible by the user. By providing an integrated method for delivering missed called notifications for multiple phone types to a subscriber, the subject matter herein increases the likelihood that missed calls will be returned in a timely manner.

In the examples described above, missed calls are identified by a signaling message routing node based on signaling messages received by the signaling message routing node. However, the subject matter described herein is not limited to such an embodiment. In alternate embodiment, signaling messages may be copied using signaling link probes that are external to network nodes. Such probes passively copy signaling messages that traverse signaling links in a network. The copied signaling messages may be forwarded to a platform that includes missed call identification and notification functionality, similar to that described above with regard to FIGS. 2A-2C.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for integrated notification of missed calls across a plurality of phone types, the method comprising:
(a) at a missed call identification function:
(i) detecting missed call occurrences between at least one calling party and a plurality of terminals of different types associated with a called subscriber; and
(ii) communicating messages indicating the missed call occurrences to a call log server separate from the plurality of terminals; and
(b) at the call log server:
(i) storing indications of the missed call occurrences for the called subscriber; and
(ii) notifying the subscriber of the missed call occurrences via a common terminal accessible by the subscriber.

2. The method of claim 1 wherein the called subscriber is a wireless subscriber.

3. The method of claim 1 wherein storing indications of the missed call occurrences includes storing the indications in response to the subscriber terminal being unavailable.

4. The method of claim 1 wherein detecting missed call occurrences between the at least one calling party and the called subscriber includes determining whether the calling party disconnects a call prior to the call being routed to voice mail.

5. The method of claim 1 wherein detecting missed call occurrences between the at least one calling party and the called subscriber includes detecting missed call occurrences between the at least one calling party and at least two terminals selected from the group consisting of an IP multimedia subsystem (IMS) phone, a mobile terminal, a wireline phone, and a voice over IP (VoIP) phone.

6. The method of claim 1 wherein notifying the called subscriber of the missed call occurrences includes displaying the indication of the missed call occurrences to the called subscriber via a graphical user interface (GUI).

7. The method of claim 6 wherein displaying the indication of the missed call occurrences via the GUI includes displaying at least a directory number associated with the at least one calling party.

8. The method of claim 1 wherein notifying the called subscriber of the missed call occurrences includes notifying the called subscriber of the missed call occurrences via an Internet connection between a subscriber computer and the call log server.

9. The method of claim 1 wherein notifying the called subscriber of the missed call occurrences includes notifying the subscriber of the missed call occurrences at an IMS phone.

10. The method of claim 9 wherein notifying the called subscriber of the missed call occurrences at an IMS phone includes notifying the called subscriber of the missed call occurrence at the IMS phone via an IMS short message service.

11. The method of claim 1 wherein notifying the called subscriber of the missed call occurrences includes communicating a short message service (SMS) message to a mobile terminal indicating the missed call occurrences and at least a directory number associated with the at least one calling party.

12. The method of claim 11 comprising, at the mobile terminal, displaying the directory number associated with the at least one calling party and receiving user input for selecting the directory number for establishing a call with a terminal associated with the directory number.

13. The method of claim 1 comprising, at the missed call identification function, receiving ISDN user part (ISUP) messages.

14. The method of claim 13 wherein the ISUP messages comprise messages selected from the group consisting of an ISUP answer message (ANM), an ISUP address complete message (ACM), and an ISUP release message (REL).

15. The method of claim 13 wherein detecting missed call occurrences includes detecting the missed call occurrences between the at least one calling party and the called subscriber based on communication of ISUP messages between switches associated with the at least one calling party and a switch associated with the called subscriber.

16. The method of claim 1 comprising, at the missed call routing function, receiving session initiation protocol (SIP) messages.

17. The method of claim 16 wherein the SIP messages comprise messages selected from the group consisting of a SIP re-invite message, a SIP invite message, and a SIP cancel message.

18. The method of claim 16 wherein detecting missed call occurrences includes detecting missed call occurrences between the at least one calling party and the called subscriber based on communication of SIP messages between the at least one calling party and the called subscriber.

19. The method of claim 1 comprising specifying, at a computer associated with the called subscriber, a call control action.

20. The method of claim 19 wherein the call control action includes establishing a connection between a telephone accessible by the subscriber and a calling party associated with one of the missed call occurrences.

21. The method of claim 19 wherein the call control action includes establishing a connection between one of an IMS phone, a mobile terminal, and a wireline phone accessible by the subscriber and the calling party associated with one of the missed call occurrences.

22. The method of claim 21 wherein establishing a connection between a telephone associated with the called subscriber and the at least one calling party associated with the missed call occurrences includes setting up incoming call legs to the telephone associated with the called subscriber and to the calling party associated with the missed call occurrence.

23. The method of claim 1 comprising, at a computer, an IMS phone, or a mobile terminal associated with the subscriber, displaying at least a directory number associated with the at least one calling party, and receiving user input for selecting the directory number for establishing a call with a terminal associated with the directory number.

24. The method of claim 23 wherein receiving user input includes receiving user input via a click-to-dial interface.

25. The method of claim 1 comprising, at a mobile terminal associated with the called subscriber, displaying at least a directory number associated with the at least one calling party, and receiving user input for selecting the directory number for establishing a call with a terminal associated with the directory number.

26. The method of claim 1 wherein at least one of the missed call identification function and the call log server is a component of a signaling message routing node.

27. The method of claim 1 wherein the missed call identification function is a component of one of the group consisting of a VoIP application server, an interactive voice response (IVR) device, a voice mail server, a signaling message routing node, and an S-CSCF.

28. A method for integrated notification of missed call occurrences across multiple phone types, the method comprising:
(a) logging, at a call log server, missed call occurrences for a plurality of different phone types used by a subscriber; and
(b) delivering notification of the missed call occurrences to a terminal accessible by the subscriber.

29. The method of claim 28 wherein logging missed call occurrences for a plurality of different phone types includes logging missed call occurrences for at least two of a mobile phone, a VoIP phone, and a land line phone operated by the subscriber.

30. The method of claim 28 wherein delivering notification of the missed call occurrences to a terminal accessible by the subscriber includes delivering notification to a mobile terminal accessible by the subscriber.

31. The method of claim 28 wherein delivering notification of the missed call occurrences to a terminal accessible by the subscriber includes delivering notification to a computer terminal accessible by the subscriber.

32. A system for integrated notification of missed calls across a plurality of phone types, the system comprising:
(a) a missed call identification function operable to:
(i) detect missed call occurrences between at least one calling party and a plurality of terminals of different types associated with a called subscriber; and
(ii) communicating messages indicating the missed call occurrences to a call log server separate from the plurality of terminals; and
(b) a call log server separate from a subscriber terminal and operable to:
(i) storing indications of the missed call occurrences for the called subscriber; and
(ii) notifying the subscriber of the missed call occurrences via a common terminal accessible by the subscriber.

33. The system of claim 32 wherein the subscriber is a wireless subscriber.

34. The system of claim 32 wherein the call log server is operable to store the indications in response to the subscriber terminal being unavailable.

35. The system of claim 32 wherein the missed call routing function is operable to determine whether the calling party disconnects the call prior to the call being routed to voice mail.

36. The system of claim 32 wherein the missed call routing function is operable to detect missed call occurrences between the at least one calling party and at least two terminals selected from the group consisting of an IP multimedia subsystem (IMS) phone, a mobile terminal, a wireline phone, and a voice over IP (VoIP) phone.

37. The system of claim 32 wherein the call log server is operable to display the indication of the missed call occurrences to the called subscriber via a graphical user interface (GUI).

38. The system of claim 37 wherein the call log server is operable to display at least a directory number associated with the at least one calling party.

39. The system of claim 32 wherein the call log server is operable to notify the called subscriber of the missed call occurrences via an Internet connection between a subscriber computer and the call log server.

40. The system of claim 32 wherein the call log server is operable to notify the subscriber of the missed call occurrences at an IMS phone.

41. The system of claim 32 wherein the call log server is operable to notify the called subscriber of the missed call occurrences at the IMS phone via an IMS short message service.

42. The system of claim 32 wherein the call log server is operable to communicate a short message service (SMS) message to a subscriber terminal indicating the missed call occurrence and at least a directory number associated with the calling party.

43. The system of claim 42 wherein the subscriber terminal is operable to display the directory number associated with the at least one calling party and receive user input for selecting the directory number for establishing a call with a terminal associated with the directory number.

44. The system of claim 32 wherein the missed call routing function is operable to receive ISDN user part (ISUP) messages.

45. The system of claim 44 wherein the missed call routing function is operable to receive messages selected from the group consisting of an ISUP answer message (ANM), an ISUP address complete message (ACM), and an ISUP release message (REL).

46. The system of claim 44 wherein the missed call routing function is operable to detect the missed call occurrences between the at least one calling party and the called subscriber based on communication of ISUP messages between switches associated with the at least one calling party and a switch associated with the-called subscriber.

47. The system of claim 32 wherein the missed call routing function is operable to receive session initiation protocol (SIP) messages.

48. The system of claim 47 wherein the missed call routing function is operable to receive messages selected from the group consisting of a SIP re-invite message, a SIP invite message, and a SIP cancel message.

49. The system of claim 37 wherein the missed call routing function is operable to detect missed call occurrences between the at least one calling party and the called subscriber based on communication of SIP messages between the at least one calling party and the called subscriber.

50. The system of claim 32 comprising a computer associated with the subscriber, wherein the computer is operable to receive user input for specifying a call control action.

51. The system of claim 50 wherein the computer is operable to communicate instructions for establishing a connection between a telephone accessible by the subscriber and a calling party associated with one of the missed call occurrences.

52. The system of claim 50 wherein the computer is operable to establish a connection between one of an IMS phone, a mobile terminal, and a wireline phone accessible by the subscriber and the calling party associated with one of the missed call occurrences.

53. The system of claim 50 wherein the computer is operable to communicate instructions for setting up incoming call legs to the telephone associated with the subscriber and to the calling party associated with one of the missed call occurrences.

54. The system of claim 32 comprising one of a computer, an IMS phone, and a mobile terminal associated with the called subscriber, wherein the one of the computer, the IMS phone, and the mobile terminal is operable to display at least a directory number associated with the at least one calling party, and receive user input for selecting the directory number for establishing a call with a terminal associated with the directory number.

55. The system of claim 54 wherein the one of the computer, the IMS phone, and the mobile terminal includes a click-to-dial interface operable to receive the user input.

56. The system of claim 32 comprising a mobile terminal associated with the called subscriber, wherein the mobile terminal is operable to display at least a directory number associated with the at least one calling party, and operable to receive user input for selecting the directory number for establishing a call with a terminal associated with the directory number.

57. The system of claim 32 wherein at least one of the missed call identification function and the call log server is a component of a signaling message routing node.

58. The system of claim 32 wherein the missed call identification function is a component of one of the group consisting of a VoIP application server, an interactive voice response (IVR) device, a voice mail server, a signaling message routing node, and an S-CSCF.

59. A system for integrated notification of missed call occurrences across multiple phone types, the system comprising:
(a) a call log server operable to log missed call occurrences for a plurality of different phone types used by a subscriber; and
(b) a missed call identification function operable to deliver notification of the missed call occurrences to a terminal accessible by the subscriber.

60. The system of claim 59 wherein the call log server is operable to log missed call occurrences for at least two of a mobile phone, a VoIP phone, and a land line phone operated by the subscriber.

61. The system of claim 59 wherein the missed call identification function is operable to deliver notification to a mobile terminal accessible by the subscriber.

62. The system of claim 59 wherein the missed call identification function is operable to deliver notification to a computer terminal accessible by the subscriber.

63. A computer program product comprising computer executable instructions embodied in a computer readable medium for performing steps comprising:
(a) at a missed call identification function:
(i) detecting missed call occurrences between at least one calling party and a plurality of terminals of different types associated with a called subscriber; and
(ii) communicating messages indicating the missed call occurrences to a call log server separate from the plurality of terminals; and
(b) at the call log server:
(i) storing indications of the missed call occurrences for the called subscriber; and
(ii) notifying the subscriber of the missed call occurrences via a common terminal accessible by the subscriber.

64. The computer program product of claim 63 wherein the called subscriber is a wireless subscriber.

65. The computer program product of claim 63 wherein storing indications of the-missed call occurrences includes storing the indications in response to the subscriber terminal being unavailable.

66. The computer program product of claim 63 wherein detecting missed call occurrences between the at least one calling party and the called subscriber includes determining whether the calling party disconnects a call prior to the call being routed to voice mail.

67. The computer program product of claim 63 wherein detecting missed call occurrences between the at least one calling party and the called subscriber includes detecting missed call occurrences between the at least one calling party and at least two terminals selected from the group consisting of an IP multimedia subsystem (IMS) phone, a mobile terminal, a wireline phone, and a voice over IP (VoIP) phone.

68. The computer program product of claim 63 wherein notifying the called subscriber of the missed call occurrences includes displaying the indication of the missed call occurrences to the called subscriber via a graphical user interface (GUI).

69. The computer program product of claim 68 wherein displaying the indication of the missed call occurrences via the GUI includes displaying at least a directory number associated with the at least one calling party.

70. The computer program product of claim 63 wherein notifying the called subscriber of the missed call occurrences includes notifying the called subscriber of the missed call occurrences via an Internet connection between a subscriber computer and the call log server.

71. The computer program product of claim 63 wherein notifying the called subscriber of the missed call occurrences includes notifying the subscriber of the missed call occurrences at an IMS phone.

72. The computer program product of claim 71 wherein notifying the called subscriber of the missed call occurrences at an IMS phone includes notifying the called subscriber of the missed call occurrence at the IMS phone via an IMS short message service.

73. The computer program product of claim 63 wherein notifying the called subscriber of the missed call occurrences includes communicating a short message service (SMS) message to a mobile terminal indicating the missed call occurrences and at least a directory number associated with the at least one calling party.

74. The computer program product of claim 73 comprising, at the mobile terminal, displaying the directory number associated with the at least one calling party and receiving user input for selecting the directory number for establishing a call with a terminal associated with the directory number.

75. The computer program product of claim 63 comprising, at the missed call identification function, receiving ISDN user part (ISUP) messages.

76. The computer program product of claim 75 wherein the ISUP messages comprise messages selected from the group consisting of an ISUP answer message (ANM), an ISUP address complete message (ACM), and an ISUP release message (REL).

77. The computer program product of claim 75 wherein detecting missed call occurrences includes detecting the missed call occurrences between the at least one calling party and the called subscriber based on communication of ISUP messages between switches associated with the at least one calling party and a switch associated with the called subscriber.

78. The computer program product of claim 63 comprising, at the missed call routing function, receiving session initiation protocol (SIP) messages.

79. The computer program product of claim 78 wherein the SIP messages comprise messages selected from the group consisting of a SIP re-invite message, a SIP invite message, and a SIP cancel message.

80. The computer program product of claim 78 wherein detecting missed call occurrences includes detecting missed call occurrences between the at least one calling party and the called subscriber based on communication of SIP messages between the at least one calling party and the called subscriber.

81. The computer program product of claim 63 comprising specifying, at a computer associated with the called subscriber, a call control action.

82. The computer program product of claim 81 wherein the call control action includes establishing a connection between a telephone accessible by the subscriber and a calling party associated with one of the missed call occurrences.

83. The computer program product of claim 81 wherein the call control action includes establishing a connection between one of an IMS phone, a mobile terminal, and a wireline phone accessible by the subscriber and the calling party associated with one of the missed call occurrences.

84. The computer program product of claim 83 wherein establishing a connection between a telephone associated with the called subscriber and the at least one calling party associated with the missed call occurrences includes setting up incoming call legs to the telephone associated with the called subscriber and to the calling party associated with the missed call occurrence.

85. The computer program product of claim 63 comprising, at a computer, an IMS phone, or a mobile terminal associated with the subscriber, displaying at least a directory number associated with the at least one calling party, and receiving user input for selecting the directory number for establishing a call with a terminal associated with the directory number.

86. The computer program product of claim 85 wherein receiving user input includes receiving user input via a click-to-dial interface.

87. The computer program product of claim 63 comprising, at a mobile terminal associated with the called subscriber, displaying at least a directory number associated with the at least one calling party, and receiving user input for selecting the directory number for establishing a call with a terminal associated with the directory number.

88. The computer program product of claim 63 wherein at least one of the missed call identification function and the call log server is a component of a signaling message routing node.

89. The computer program product of claim 63 wherein the missed call identification function is a component of one of the group consisting of a VoIP application server, an interactive voice response (IVR) device, a voice mail server, a signaling message routing node, and an S-CSCF.

90. A computer program product comprising computer executable instructions embodied in a computer readable medium for performing steps comprising:
(a) logging, at a call log server, missed call occurrences for a plurality of different phone types used by a subscriber; and
(b) delivering notification of the missed call occurrences to a terminal accessible by the subscriber.

91. The computer program product of claim 90 wherein logging missed call occurrences for a plurality of different phone types includes logging missed call occurrences for at least two of a mobile phone, a VoIP phone, and a land line phone operated by the subscriber.

92. The computer program product of claim 90 wherein delivering notification of the missed call occurrences to a terminal accessible by the subscriber includes delivering notification to a mobile terminal accessible by the subscriber.

93. The computer program product of claim 90 wherein delivering notification of the missed call occurrences to a terminal accessible by the subscriber includes delivering notification to a computer terminal accessible by the subscriber.
